(19) United States
(12) Patent Application Publication
(10) Pub. No.: US 2010/0260928 A1
(43) Pub. Date: Oct. 14, 2010

(54) METHOD FOR PRODUCING FUEL CELL SEPARATOR

(75) Inventors: Hajime Hasegawa, Toyota-shi (JP); Kuroudo Maeda, Miyoshi-shi (JP); Takeshi Nagasawa, Okazaki-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/742,284

(22) PCT Filed: Oct. 29, 2008
(86) PCT No.: PCT/JP2008/069618

§ 371 Date: May 11, 2010

(30) Foreign Application Priority Data
Nov. 12, 2007 (JP) 2007-292822

(51) Int. Cl. B05D 5/12

(52) U.S. Cl. 427/115

(57) ABSTRACT

A method for producing a fuel cell separator which suppresses increase in an electrical conductivity of a coolant to reduce the contact resistance. A method for producing the fuel cell separator for separating gases between adjacent cells for the fuel cell which includes forming a separator substrate having projections and recesses from a metal material such as a titanium material or a stainless steal, and forming an electrical-conductive layer with an electrical conductor of gold or the like only on the projections of the separator substrate.

### TECHNICAL FIELD

The present invention relates to a method for producing a fuel cell separator, and especially to a method for producing a fuel cell separator that separates gases between adjacent cells for a fuel cell.

### BACKGROUND ART

In recent years, fuel cells have attracted increasing attention for their high efficiency and excellent environmental characteristics. Fuel cells generally produce electrical energy through an electrochemical reaction of hydrogen as a fuel gas with oxygen in air as an oxidant gas. As a result of the electrochemical reaction between hydrogen and oxygen, water is produced.

There are various kinds of fuel cells, including phosphoric acid fuel cells, molten carbonate fuel cells, solid oxide fuel cells, alkali fuel cells, solid polymer fuel cells, and so forth. Among these, attention has been focused on solid polymer fuel cells that are advantageous in that they are capable of cold start, the startup time is short, etc. Such solid polymer fuel cells are used as, for example, power sources for mobile bodies such as vehicles.

A solid polymer fuel cell is assembled by laminating a plurality of single cells, a collector plate, an end plate, and the like. Each cell for a fuel cell is configured to include an electrolyte membrane, a catalyst layer, a gas diffusion layer, and a separator.

Patent Document 1 discloses a fuel cell separator including a metal plate, the metal plate having a gas channel portion and a contact portion that is located outside the gas channel portion and in contact with a cell voltage monitor terminal. At the gas channel portion, the metal plate is plated with a metal, and a carbon coating is applied thereon. At the contact portion that is located outside the gas channel portion and in contact with a cell voltage monitor terminal, by masking the contact portion during the application of the carbon coating, the metal plate remains metal-plated.

Patent Document 1: Japanese Patent No. 3891069

### DISCLOSURE OF THE INVENTION

### Problems that the Invention is to Solve

Incidentally, in the case where a fuel cell separator is produced from a metal material such as titanium, generally, gold (Au) or a similar electrical conductor having a high electrical conductivity is applied to the surface thereof by plating or the like, thereby reducing the contact resistance between the fuel cell separator and the gas diffusion layer, etc. Here, if the plating with gold (Au) or a similar electrical conductor is also applied to a coolant-channel surface of the separator, then the electrical conductivity of the coolant may be increased due to the catalytic activity of gold (Au) or the like, for example.

The invention provides a method for producing a fuel cell separator, which suppresses an increase in the electrical conductivity of a coolant so as to reduce the contact resistance between the fuel cell separator and a gas diffusion layer, etc.

### Means for Solving the Problems

A method for producing a fuel cell separator according to the invention is a method for producing a fuel cell separator that separates gases between adjacent cells for a fuel cell. The method includes: forming a separator-substrate having projections and recesses from a metal material; and forming an electrically-conductive-layer only on the projections of the separator substrate from an electrical conductor.

In the method for producing a fuel cell separator, it is preferable that in forming the electrically-conductive-layer, metal plating is applied only to the projections of the separator substrate to form the electrically conductive layer.

In the method for producing a fuel cell separator, it is preferable that the metal plating is gold plating.

In the method for producing a fuel cell separator, it is preferable that in forming the separator-substrate, the separator substrate is formed from a titanium material or a stainless steel.

In the method for producing a fuel cell separator, it is preferable that in forming the electrically-conductive-layer, the electrically conductive layer is formed by roller plating using a roller that holds a plating solution on the surface thereof.

### ADVANTAGE OF THE INVENTION

As mentioned above, the method for producing a fuel cell separator according to the invention prevents an electrically conductive layer of gold (Au) or the like from being formed on a coolant-channel surface of the separator, thus making it possible to suppress an increase in the electrical conductivity of the coolant, thereby reducing the contact resistance between the fuel cell separator and a gas diffusion layer, etc.

### BRIEF DESCRIPTION OF THE DRAWINGS

FIG. 1 shows a sectional view of a cell for a fuel cell according to one embodiment of the invention.

FIG. 2 shows a flow chart representing a method for producing a fuel cell separator according to one embodiment of the invention.

FIG. 3 shows the configuration of a plating apparatus according to one embodiment of the invention.

FIG. 4 shows a case where an electrically conductive layer is formed using a plating apparatus according to one embodiment of the invention.

FIG. 5 shows a case where an electrically conductive layer is formed using a sputtering apparatus according to one embodiment of the invention.

FIG. 6A shows a schematic diagram of a dimple-like separator including an electrically conductive layer (top view as seen from the coolant side) according to one embodiment of the invention.

FIG. 6B shows an enlarged view of the dimple region of FIG. 6A.

FIG. 6C shows an A-A sectional view of the dimple region of FIG. 6B.

FIG. 7 shows the results of measurement of the coolant electrical conductivity according to one embodiment of the invention.

### DESCRIPTION OF THE REFERENCE NUMERALS AND SIGNS

10: Cell for a fuel cell, 12: Electrolyte membrane, 14: Catalyst layer, 16: Gas diffusion layer, 18: Membrane electrode assembly, 20, 29: Separator, 22: Separator substrate, 24: Electrically conductive layer, 26: Gas channel, 28: Coolant channel, 30: Plating apparatus, 32: Plating bath, 34: First roller, 36: Second roller, 38: Liquid-retaining material, 40: Plating solution, 50: Dimple-like separator, 52: Cylindrical protrusion, 54: Gas-channel surface, 56: Coolant-channel surface

### BEST MODE FOR CARRYING OUT THE INVENTION

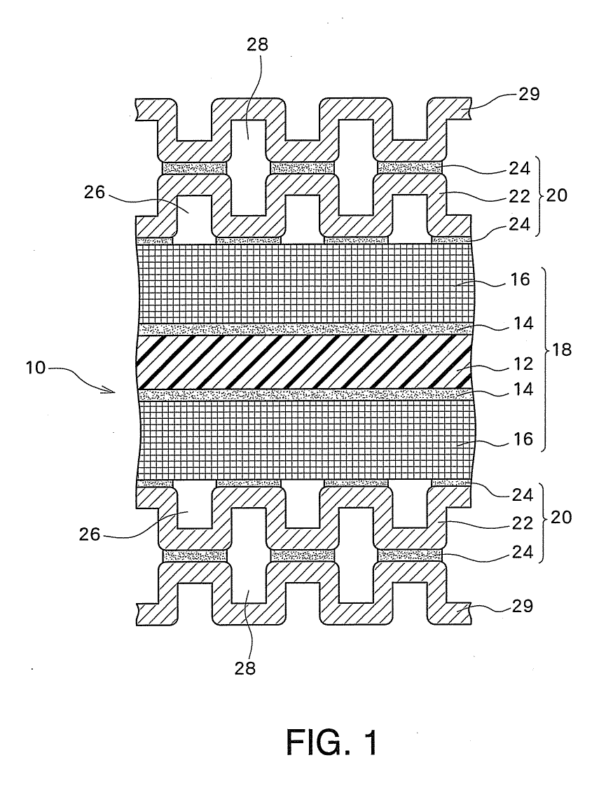

Hereinafter, an embodiment of the invention will be described in detail with reference to the drawings. First, the configuration of a cell for a fuel cell will be explained. FIG. 1 shows a sectional view of a cell 10 for a fuel cell. The cell 10 for a fuel cell includes: a membrane electrode assembly 18 (MEA) that integrates an electrolyte membrane 12, a catalyst layer 14, and a gas diffusion layer 16, and provides fuel cell electrodes; and a separator 20 that separates fuel and oxidant gases between adjacent cells for a fuel cell. The cell 10 for a fuel cell shown in FIG. 1 is one instance, and the invention is not limited to this configuration.

The electrolyte membrane 12 has the functions of moving hydrogen ions generated on the anode side to the cathode side, etc. The material for the electrolyte membrane 12 may be a chemically stable fluororesin, and an example thereof is a perfluorocarbon sulfonate ion exchange membrane.

The catalyst layer 14 has the function of accelerating the hydrogen oxidation reaction on the anode side or the oxygen reduction reaction on the cathode side. The catalyst layer 14 includes a catalyst and a catalyst carrier. In order to increase the reaction area of the electrode, the catalyst is generally used in the form of particles attached to the catalyst carrier. An example of the catalyst is platinum, which is a platinum-group element showing less activation overpotential for the hydrogen oxidation reaction or the oxygen reduction reaction. As the catalyst carrier, a carbon material such as carbon black can be used, for example.

The gas diffusion layer 16 has the functions of diffusing a hydrogen gas or the like that serves as a fuel gas and air or the like that serves as an oxidant gas into the catalyst layer 14, moving electrons, and so forth. A carbon fiber woven fabric, carbon paper, or a similar material having electrical conductivity can be used for the gas diffusion layer 16.

The separator 20 is laminated onto the membrane electrode assembly 18, and has the function of separating fuel and oxidant gases between adjacent cells for a fuel cell. The separator 20 also has the function of electrically connecting adjacent cells for a fuel cell. The separator 20 has a separator substrate 22 formed from a metal material and having projections and recesses, and also has an electrically conductive layer 24 formed only on the projections of the separator substrate 22. The provision of the separator with projections and recesses can lead to the formation of a gas channel 26 where a fuel gas or an oxidant gas flows and a coolant channel 28 where a coolant LLC (Long-Life-Coolant) containing ethylene glycol or the like flows.

The separator substrate 22 is preferably formed from a titanium material such as titanium or a titanium alloy, or from a stainless steel such as SUS316L or SUS304. This may be because these metal materials have high mechanical strength. Further, such a metal material may allow the formation of an inactive film, such as a passivation film containing a stable oxide (TiO, Ti₂O₃, TiO₂, CrO₂, CrO, Cr₂O₃, etc), on the surface thereof, and thus exhibit excellent corrosion resistance. As the stainless steel, austenitic stainless steel, ferritic stainless steel, or the like is usable. Needless to say, depending on other conditions, the separator substrate 22 may be formed from a different metal material without limitation to the above metal materials.

The electrically conductive layer 24 can be formed from gold (Au), silver (Ag), copper (Cu), platinum (Pt), rhodium (Rh), iridium (Ir), palladium (Pd), or a similar metal material that serves as an electrical conductor. This may be because these metal materials have a high electrical conductivity, and therefore the contact resistance can be further reduced between the separator 20 and the membrane electrode assembly 18 or a separator 29 of the adjacent cell for a fuel cell. Among these metal materials, gold (Au) has excellent corrosion resistance, exhibits a high electrical conductivity, and thus is preferable as the metal material for forming the electrically conductive layer 24. The electrically conductive layer 24 may also be made of an alloy of gold (Au), platinum (Pt), and the like.

Further, in order to increase the amount of fuel gas or oxidant gas flowing between the gas diffusion layer 16 and the separator 20, a gas channel structure (not illustrated) such as an expanded metal, a metal lath, or a porous metal material may also be provided.

Next, a method for producing the fuel cell separator 20 will be explained.

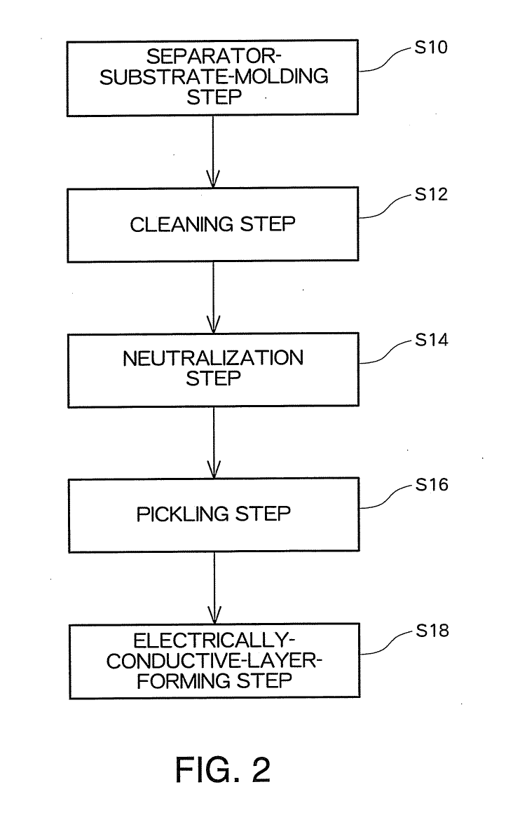

FIG. 2 shows a flow chart representing a method for producing the fuel cell separator 20. The method for producing the fuel cell separator 20 includes a separator-substrate-forming step (S10), a cleaning step (S12), a neutralization step (S14), a pickling process (S16), and an electrically-conductive-layer-forming step (S18).

The separator-substrate-forming step (S10) is a step of processing a metal material to have projections and recesses, thereby giving the separator substrate 22. The separator substrate 22 can be formed by pressing a metal sheet, for example. The separator substrate 22 may have a dimple-like shape, a corrugated shape, or the like, with projections and recesses. As a processor, one for use in press working of a metal material, for example, is generally used.

The cleaning step (S12) is a step of cleaning the separator substrate 22. The separator substrate 22 can be cleaned, for example, by alkali dipping degreasing. An alkaline solution such as caustic soda, for example, can be employed in alkali dipping degreasing. Cleaning the separator substrate 22 by alkali dipping degreasing or the like may remove oil and so forth adhering to the surface of the separator substrate 22.

The neutralization step (S14) is a step of neutralizing and removing the alkali solution remaining on the cleaned separator substrate 22. Neutralization can be performed, for example, by immersing the cleaned separator substrate 22 in a neutralizing solution. A sulfuric acid solution, a hydrochloric acid solution, a nitric acid solution, or the like can be employed as the neutralizing solution. The separator substrate 22 removed from the neutralizing solution may be washed with deionized water or the like.

The pickling step (S16) is a step of washing the neutralized separator substrate 22 with an acid to remove oxides and the like from the surface of the separator substrate 22. Pickling can be performed, for example, by immersing the separator substrate 22 in a fluoride-containing solution such as a nitric-hydrofluoric acid solution or a hydrofluoric acid solution. As a result of immersion of the separator substrate 22 in the fluoride-containing solution, oxides and the like produced on the surface of the separator substrate 22 can be etched. The separator substrate 22 removed from the fluoride-containing solution or the like may be washed with deionized water or the like.

The electrically-conductive-layer-forming step (S18) is a step of forming, from gold (Au) or a similar electrical conductor, the electrically conductive layer 24 on the projections of the pickled separator substrate 22. To apply a coating of gold (Au) or the like, metal plating by electrolytic plating can be employed, for example. The electrolytic plating may be ordinary electrolytic plating of gold (Au), silver (Ag), copper (Cu), or the like.

In the case where a gold (Au)-plating layer is applied as the electrically conductive layer 24 onto the projections of the separator substrate 22, a gold-plating bath containing gold potassium cyanide, gold sodium sulfite, or the like can be used, for example. As the gold-plating bath, an alkaline, neutral, or acidic plating bath can be used. Further, the particle diameter of the gold (Au) particles or the like forming the electrically conductive layer 24 can be controlled by the current density, the plating time, additives, etc.

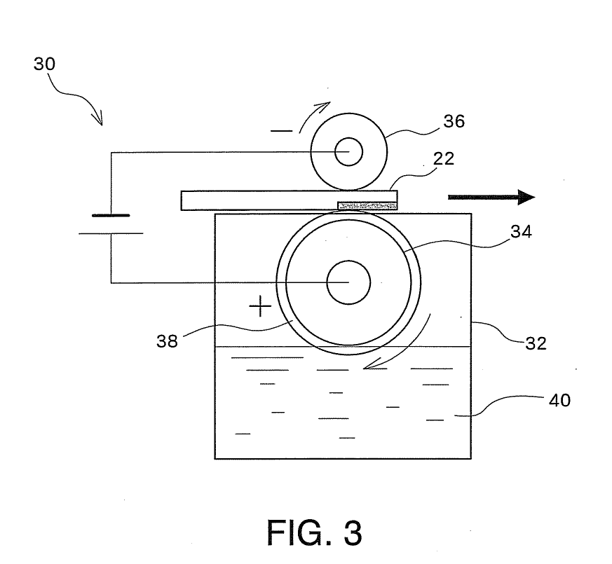

FIG. 3 shows the configuration of a plating apparatus 30 for roller plating using a roller that holds a plating solution on the surface thereof. The plating apparatus 30 includes a plating bath 32 that collects a plating solution 40, a first roller 34 that picks up the plating solution 40, and a second roller 36 that holds, together with the first roller 34, the separator substrate 22 therebetween under a predetermined pressure.

The first roller 34 and the second roller 36 can be made of, for example, a stainless steel having excellent corrosion resistance. The first roller 34 preferably has on the surface thereof a liquid-retaining material 38, such as a rayon nonwoven fabric (felt), for holding a plating solution. The first roller 34 and the second roller 36 can be connected to a power supply, where the first roller 34 can be connected to the anode, and the second roller 36 can be connected to the cathode.

When the plating solution picked up by the first roller 34 comes in contact with the separator substrate 22, the resulting contact portion of the separator substrate 22 can be plated with an electrical conductor. After one side of the separator substrate 22 is brought into contact with the first roller 34, so that projections on one side can be plated with the electrical conductor, then the other side of the separator substrate 22 can be brought into contact with the first roller 34, so that projections on the other side can be plated with the electrical conductor. As a result, the electrically conductive layer 24 can be formed from the electrical conductor on the projections of the separator substrate 22, which are in contact with the membrane electrode assembly 18 or with the separator 29 of the adjacent cell for a fuel cell. This plating apparatus 30 can allow the formation of the electrically conductive layer 24 only on the projections without the need for masking other portions such as the gas-channel surface, the coolant-channel surface, and the like. Therefore, the production cost for the fuel cell separator 20 can be reduced.

Further, even in the case where the separator substrate 22 formed by pressing or the like is warped or swollen, because plating can be applied with the separator substrate 22 being under a predetermined pressure given by the first roller 34 and the second roller 36, substantially uniform plating can be applied to the projections of the separator substrate 22.

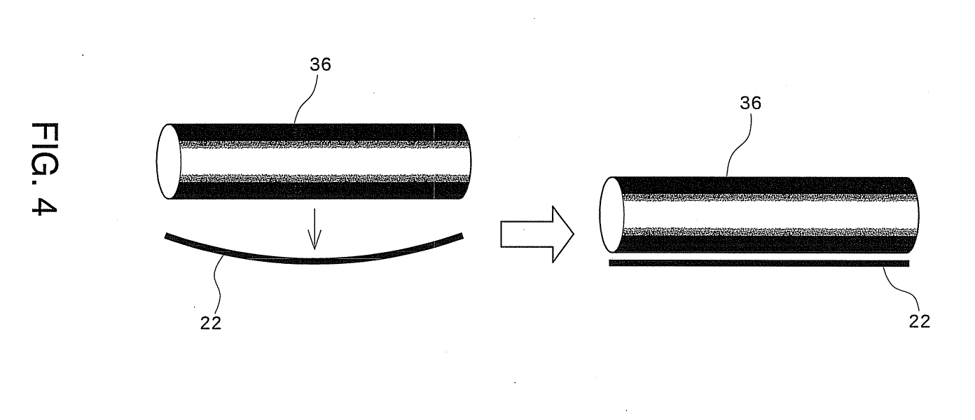

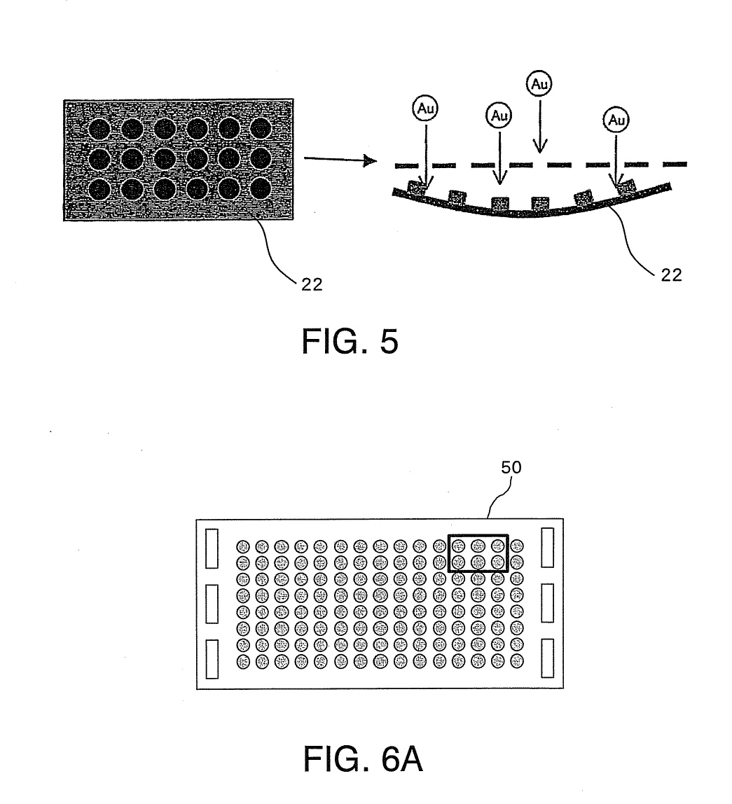

FIG. 4 shows a case where the electrically conductive layer 24 is formed using the plating apparatus 30. FIG. 5 shows a case where the electrically conductive layer 24 is formed using a sputtering apparatus. The left-hand drawing shows a top view of the separator substrate 22, while the right-hand drawing shows a side view indicating how sputtering works. As shown in FIG. 4, even when the separator substrate 22 is warped or swollen, correction is possible by increasing the pressing pressure of the second roller 36. Therefore, substantially uniform plating can be applied to the projections of the separator substrate 22. In contrast, as shown in FIG. 5, in the case where an electrically conductive layer of gold (Au) or the like is formed on the separator substrate 22 using a sputtering apparatus or the like, when the separator substrate 22 is warped or swollen, it may be difficult to sputter the target region, and it may be thus difficult to form a substantially uniform electrically conductive layer on the projections of the separator substrate 22. Therefore, in the case where the electrically conductive layer is formed using a sputtering apparatus or the like, a correction step such as annealing may be required in order to correct warping or swelling of the separator substrate 22. In the case where the electrically conductive layer 24 is formed using the plating apparatus 30 shown in FIG. 3, the correction step such as annealing may be not required even when the separator substrate 22 is warped or swollen, and therefore the production cost for the fuel cell separator 20 can be further reduced.

Needless to say, the method for forming the electrically conductive layer is not limited to the above-described electrolytic plating, and other coating methods including physical vapor deposition (PVD), chemical vapor deposition (CVD), an application method, an ink-jet method, and the like are also usable. In the physical vapor deposition (PVD), for example, sputtering or ion plating may be employed to form a coating of gold (Au) or the like. In the application method, particles of gold (Au) or the like can be dispersed in a binder such as an organic solvent to thereby prepare a slurry, and the slurry having the particles of gold (Au) or the like dispersed therein can be applied to form a coating. In the ink-jet method, for example, an ultrafine metal ink having particles of gold (Au) or the like dispersed therein can be used to form a coating.

In the case where the electrically conductive layer 24 is formed from gold, the thickness of the electrically conductive layer 24 is preferably not less than about 2 nm and not more than about 100 nm. This is because when the thickness of the electrically conductive layer 24 is less than about 2 nm, the contact resistance of the resulting separator 20 may be high. This is also because when the thickness of the electrically conductive layer 24 is more than 100 nm, this may increase the production cost, as the gold forming the electrically conductive layer 24 is expensive. In addition, in the case where the electrically conductive layer 24 is formed from gold, the thickness of the electrically conductive layer 24 is more preferably not less than about 2 nm and not more than about 20 nm. The production of the fuel cell separator 20 can be thus completed.

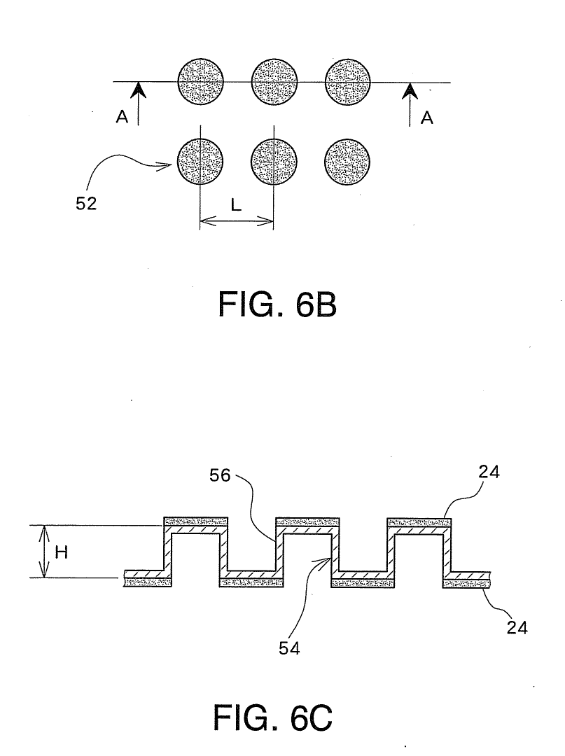

FIG. 6 show a dimple-like separator 50 including the electrically conductive layer 24. FIG. 6A shows a schematic diagram of the dimple-like separator 50 (top view as seen from the coolant side), FIG. 6B shows an enlarged view of the dimple region, and FIG. 6C shows an A-A sectional view of the dimple region of FIG. 6B. As shown in FIGS. 6B and 6C, the outer diameter of a cylindrical protrusion 52 may be about 0.5 mm to about 3.0 mm, for example; the pitch L of the cylindrical protrusion 52 may be about 0.6 mm to about 5.0 mm, for example; and the height H of the cylindrical protrusion may be about 0.05 mm to about 0.6 mm, for example. The electrically conductive layer 24, such as a gold (Au)-plating layer, can be formed only on the projections that are in contact with a membrane electrode assembly 18 or a separator of the adjacent cell for a fuel cell, and can be not formed on a gas-channel surface 54 where a fuel gas or an oxidant gas flows or on a coolant-channel surface 56 where a coolant flows. In order to improve corrosion resistance, the gas-channel surface 54 of the separator 50 may be coated with a titanium oxide (TiO₂) or the like.

The above configuration prevents the electrically conductive layer of gold (Au) or the like from being formed on the coolant-channel surface of the fuel cell separator, thus making it possible to suppress an increase in the electrical conductivity of the coolant, thereby reducing the contact resistance between the fuel cell separator and a gas diffusion layer, etc.

By employing the above configuration, the electrically conductive layer of gold (Au) or the like can be formed only on the contact surface in contact with the membrane electrode assembly 18 or a separator of the adjacent cell for a fuel cell, and therefore, the production cost for cells for a fuel cell can be further reduced.

### Examples

Hereinafter, the present invention will be described in further detail with reference to Examples and Comparative Examples; however, the invention is not limited thereto.

Three kinds of separator specimens are produced, and changes in the electrical conductivity of a coolant are evaluated.

First, a method for producing a separator specimen of Example 1 will be explained. A pure titanium sheet is pressed to form a titanium sheet having projections and recesses, followed by cleaning by alkali dipping degreasing to remove oil adhering to the titanium sheet having projections and recesses. After alkali dipping degreasing, the processed titanium sheet having projections and recesses is immersed in a sulfuric acid solution for neutralization. The titanium sheet having projections and recesses is then immersed in a nitric-hydrofluoric acid solution for pickling, and oxides produced on the surface of the titanium sheet having projections and recesses are removed by etching. Subsequently, a gold-plating layer that serves as the electrically conductive layer is formed only on the projections of the pickled titanium sheet having projections and recesses. The gold-plating layer is formed by electrolytic plating using an alkaline gold-plating bath. For gold plating, the plating apparatus 30 shown in FIG. 3 is used. The thickness of the gold-plating layer is 10 nm.

Next, a method for producing a separator specimen of Comparative Example 1 will be explained. A pure titanium sheet is pressed to form a titanium sheet having projections and recesses, followed by cleaning by alkali dipping degreasing to remove oil adhering to the titanium sheet having projections and recesses. After alkali dipping degreasing, the processed titanium sheet having projections and recesses is immersed in a sulfuric acid solution for neutralization. The titanium sheet having projections and recesses is then immersed in a nitric-hydrofluoric acid solution for pickling, and oxides produced on the surface of the titanium sheet having projections and recesses are removed by etching. Subsequently, a gold-plating layer that serves as the electrically conductive layer is formed over the entire surface of the pickled titanium sheet having projections and recesses. The gold-plating layer is formed by electrolytic plating using an alkaline gold-plating bath. The gold-plating layer is formed by immersing the pickled titanium sheet having projections and recesses in a gold-plating solution. The thickness of the gold-plating layer is 10 nm. As a separator specimen of Comparative Example 2, one having no gold-plating layer is used.

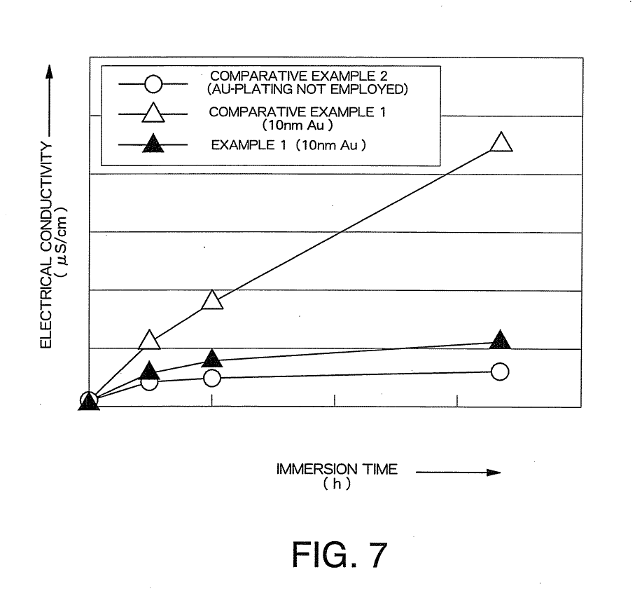

Each of the three kinds of separator specimens is immersed in a coolant, and the electrical conductivity of the coolant is evaluated. The electrical conductivity of the coolant is measured by an ordinary method for measuring the electrical conductivity of a liquid. As the coolant, an LLC (Long Life Coolant) containing ethylene glycol and the like is used. FIG. 7 shows the results of the measurement of the coolant electrical conductivity. As shown in FIG. 7, the abscissa represents the time of immersion in a coolant, and the ordinate is electrical conductivity (μS/cm). The electrical conductivity of the coolant in which the separator specimen of Example 1 is immersed is indicated by black triangles, the electrical conductivity of the coolant in which the separator specimen of Comparative Example 1 is immersed is indicated by white triangles, and the electrical conductivity of the coolant in which the separator specimen of Comparative Example 2 is immersed is indicated by white circles. With respect to the coolant in which the separator specimen of Comparative Example 1 is immersed, the electrical conductivity thereof increases with the lapse of immersion time. In contrast, the electrical conductivity of the coolant in which the separator specimen of Example 1 is immersed shows almost no increase with the lapse of immersion time. This is probably because, compared with the separator specimen of Comparative Example 1, the gold-plating layer of the separator specimen of Example 1 is formed in a smaller area, and the catalytic activity of gold (Au) on the LLC is thus smaller.

1. A method for producing a fuel cell separator for separating gases between adjacent cells for a fuel cell, comprising:
forming a separator-substrate having projections and recesses from a metal material, and
forming an electrically-conductive-layer only on the projections of the separator substrate from an electrical conductor,
wherein in forming the electrically-conductive layer, the electrically-conductive layer is formed by applying metal plating by roller plating in which a first roller retaining a plating solution on a roller surface thereof and a second roller which holds, together with the first roller, the separator substrate therebetween under a predetermined pressure are used.

2. (canceled)

3. A method for producing a fuel cell separator according to claim 1, wherein the metal plating is gold plating.

4. A method for producing a fuel cell separator according to claim 1, wherein in forming the separator-substrate, the separator substrate is formed from a titanium material or a stainless steel.

5. (canceled)

6. A method for producing a fuel cell separator according to claim 1, wherein the electrically-conductive layer is formed by picking up the plating solution by a liquid-retaining material provided on the roller surface of the first roller from a plating solution bath storing the plating solution and bringing the plating solution into contact with the projections of the separator substrate.

7. A method for producing a fuel cell separator according to claim 6, wherein the liquid-retaining material includes a nonwoven fabric.
